(19) United States
(12) Patent Application Publication
(10) Pub. No.: US 2010/0267876 A1
(43) Pub. Date: Oct. 21, 2010

(54) WATER BORNE COATING COMPOSITION CONTAINING A POLYESTERAMIDE

(75) Inventors: Antonius Hendrikus Gerardus Van Engelen, Noordwijkerhout (NL); Marysia Cornelia Wilhelmina Van Boxtel, Leiden (NL)

Correspondence Address: KENYON & KENYON LLP, ONE BROADWAY, NEW YORK, NY, 10004, US

(73) Assignee: AKZO NOBEL COATINGS INTERNATIONAL B.V., Arnhem (NL)

(21) Appl. No.: 12/305,846

(22) PCT Filed: Jun. 15, 2007
(86) PCT No.: PCT/EP2007/055941

§ 371 Date: Dec. 19, 2008

(30) Foreign Application Priority Data
Jun. 19, 2006 (EP) 06115672.5

(51) Int. Cl. C08K 5/06; C08K 5/053; C08K 5/05

(52) U.S. Cl. 524/376; 524/366; 524/386; 524/389

(57) ABSTRACT

Disclosed is a composition containing (i) 1-50 wt. % of a water-soluble, branched polyesteramide, (ii) 1-50 wt. % of a solvent selected from the group of alcohols, ethers, and ether alcohols having a boiling point in the range of 130° to 250° C., and (iii) 0-98 wt. % of water, and its use as an additive to water borne base coat compositions to reduce or eliminate problems of underspray/overspray.

The invention relates to the field of aqueous coating compositions. More particularly, the invention relates to a water borne base coat composition that contains a polyesteramide. The invention also relates to the polyesteramide and solvent-containing additive compositions per se, and to coated substrates.

### BACKGROUND OF THE INVENTION

Water borne base coats form part of so-called base coat/clear coat systems. Such systems are used to coat metal and plastic substrates in for example the automotive industry. The substrate is usually primed. The clear coat is applied subsequent to the base coat. Application is usually done by means of spraying. Such coating systems and their use are disclosed in, for example, EP-A 0287144 and EP-A 1242548.

When applying the base coat by spraying, from time to time problems arise that are designated as overspray and underspray. These problems are especially encountered under warm weather conditions and/or when spraying large objects. Overspray and/or underspray are visually observable and result in a reduction of the gloss of the base coat/clear coat system.

During the spraying operation, the operator sprays a surface with the aqueous coating composition several times, with a time interval separating the sprayings, the duration of each interval depending on factors such as the size and/or the complexity of the substrate, and the working speed. In practice, conditions such as warm weather conditions may occur that will cause paint particles to adhere to the surface of the paint without being absorbed into the previously applied paint. This is called overspray. Underspray occurs when the layer that is applied during the next spraying is not able to absorb or dissolve these paint particles. The latter then remain visible through that next layer and so contribute to the reduction of the gloss.

In daily practice, these phenomena are frequently countered by the addition of slowly evaporating solvents. A disadvantage of this in the case of the base coat is that it becomes more difficult for it to be or remain compliant with regulations limiting the emission of volatile organic compounds.

There is a continuing need for alternative solutions to the problems of overspray and/or underspray.

### SUMMARY OF THE INVENTION

It has been found that the addition to state of the art aqueous base coat compositions of an additive composition containing
(i) 1-50 wt. % of a water-soluble branched polyesteramide;
(ii) 1-50 wt. % of a solvent selected from the group of alcohols, ethers, and ether alcohols having a boiling point in the range of 130° to 250° C.; and
(iii) 0-98 wt. %, preferably 5-98 wt. %, of water, the sum of (i), (ii), and (iii) being 100%,
   results in a substantial reduction if not elimination of the problem of overspray and/or underspray when using such a base coat composition under low humidity and/or warm weather conditions.

The additive composition is suitably added in an amount of 1 to 50 wt. %, based on the weight of the aqueous base coat composition. Preferably, the amount is 5 to 50 wt. %.

### DETAILED DESCRIPTION OF THE INVENTION

Preferred branched, water-soluble polyesteramides used in accordance with the invention have a glass transition temperature (Tg) in the range of 30° to 75° C. Even more preferred are polyesteramides having a Tg in the range of 30° to 75° C., a number average molecular weight Mn in the range of 500 to 2,500, preferably in the range of 800 to 2,000, and more preferably in the range of 1,000 to 1,600, and an OH value in the range of 250 to 350, preferably in the range of 285 to 350 mg KOH/g.

The general class and the general synthesis of branched, water-soluble polyesteramides used in the compositions according to the invention are known in the art, for instance from International patent application WO 99/16810. U.S. Pat. No. 3,709,858 describes curable, water-soluble polyesteramides useful as film-forming binder resins in protective coating compositions. The compositions may contain 1 to 50 weight-% of an organic co-solvent, preferably an alcohol or glycol. The coating composition may also contain pigments.

The Mn of the polyesteramide is determined with the aid of GPC (polystyrene standards using universal calibration). The Tg is measured experimentally by means of DSC, and the OH value is expressed as mg of KOH per gram of polyesteramide.

Branched polyesteramides can be made by polycondensation of so-called AB2 monomers. The A part derives from cyclic carboxylic anhydrides, the B part from di-β-alkanolamines.

In general, the polyesteramide used according to the invention is based on
a. at least one anhydride A1,
b. optionally at least one anhydride A2,
c. at least one di-β-alkanolamine, and
d. optionally at least one monoacid
   wherein anhydride A1 is present in an amount of 50-100%, based on the total amount of anhydride, and anhydride A2 is present in an amount of 0-50%, based on the total amount of anhydride, and the monoacid is present in an amount such that 0-25% of the functional end groups is modified by the monoacid.

The polyesteramide used according to the invention is obtainable by a process comprising at least the following steps:
step 1: reacting 50-100%, based on the total amount of anhydride A1, optionally together with 0-50% of anhydride A2, with at least one di-β-alkanolamine to form an intermediate product, and
step 2: performing a polycondensation reaction on the intermediate product obtained in the first step,
   with the anhydride A1 being chosen from the list of succinic anhydride, methyl succinic anhydride, maleic anhydride, and glutaric anhydride or a combination of any of these, and the anhydride A2 being chosen from the list of hexahydro-phthalic anhydride, phthalic anhydride or methyl-hexahydrophthalic anhydride or a combination of any of these. Succinic anhydride is preferred as the anhydride A1. Hexahydro phthalic anhydride is preferred as the anhydride A2. The di-β-alkanol amine used in the preparation is not particularly critical; the person skilled in the art can easily determine which di-β-alkanol amine suits his requirements best. Preferably, di-isopropanol amine, diethanol amine or di-isobutanol amine or a combination of any of these is used; more preferably, di-isopropanol amine is used.

The amount of anhydride A1 and anhydride A2 used is based on the total amount of anhydride, thus, for example, when 80% of anhydride A1 is used, 20% of anhydride A2 is used. Anhydride A1 and anhydride A2 may be the same or different and can both consist of a mixture of the specified anhydrides. Thus it is possible to use two different anhydrides for anhydride A1 combined with two different anhydrides for anhydride A2. Another possibility is that anhydride A1 consists of a mixture while anhydride A2 is a single anhydride or, alternatively, that anhydride A2 consists of a mixture while anhydride A1 is a single anhydride.

The addition of a minor amount, that is less than 50% of the total anhydride used, of anhydride A2 was sometimes found to be advantageous, because it may improve the hardness of the final coating. A very advantageous combination of reactants for the anhydride was found to be 80% succinic anhydride, 20% hexahydrophthalic anhydride, combined with di-isopropanol amine as the di-alkanolamine.

The first step is performed at a suitable reaction temperature for the components, therefore the temperature can vary when using different starting components. However, the person skilled in the art can easily, by routine experimentation, determine the best temperature or temperature range. A generally suitable temperature range is 20-130° C. Preferably, a temperature between 40° and 100° C. is used. The temperature for the second step will also depend on the components chosen and can also be easily determined by the skilled person. A suitable temperature range will be 120-180° C., preferably 130-170° C.

The polyesteramide used according to the invention can be modified by the addition of a small amount of monoacid. By “monoacid” is meant a carboxylic acid with one carboxylic acid group available for reaction with a suitable functional group on another molecule, and having 20 carbon atoms or less. The addition of the monoacid will result in the modification of the functional end groups present on the polyesteramide as prepared in the process described above. By “small amount” is meant that 0-25% of the functional end groups is modified by the monoacid. Preferably, 0-15% of the functional end groups is modified, a lower amount of modification being preferred as this will positively influence the water solubility. The choice of monoacid is not particularly critical, as long as the upper limit of the amount is not exceeded. Examples of suitable monoacids are benzoic acid, 2-ethyl-hexanoic acid, acetic acid, and butyric acid. Benzoic acid and 2-ethyl-hexanoic acid are preferred.

The polyesteramide used according to the invention that is modified with the monoacid can be obtained by the process as described above comprising an additional step:
step 3: adding a monoacid to the reaction mixture of step 2.

The temperature for this step can be within the same range as that for step 2. It is therefore possible to combine step 3 with step 2.

The ratio between the components in step 1 can be chosen freely to fit the needs of the specific composition wherein the polyesteramide will be used. The main limiting feature will be the viscosity so as to make it possible to handle the polyesteramide and its compositions. With too high a viscosity, it will be very difficult for example to mix the polyesteramide used according to the invention with other components and/or solvents. A suitable molar ratio of amine to anhydride is between 1.0 and 1.6. Preferably, a ratio between 1.1 and 1.3 is used.

Step 2 of the process can be performed immediately after step 1 or after a certain time interval. In step 2 of the process, the intermediate product obtained in the first step is condensed to form a polymeric material. A polycondensation reaction of this type is generally known in the art.

Depending on the ratio between the anhydride and the di-β-alkanolamine used in step 1 of the process, a polyesteramide with a higher amount of hydroxyl end groups than acid end groups is obtained. These end groups are sometimes referred to as functional end groups. The amount of hydroxyl groups is expressed as the hydroxyl value (OH-value, OHV) in milligrams KOH used per g of polyesteramide. A generally suitable OH-value for the polyesteramides used according to the invention is in the range of 250 to 350 mg KOH/g. A preferred range is 285 to 350. With an OH-value within the preferred range an optimal balance between hardness of the final coating and water solubility can be obtained.

The acid value generally is much lower than the hydroxyl value for the polyesteramides used according to the invention. The number of acid groups is determined by titration of the acid/anhydride groups with KOH. The amount of acid groups is expressed as the acid value (AV) in mg KOH/g polyesteramide. A generally obtained acid value for the polyesteramides used according to the invention is between 0 and 20 mg KOH/g, preferably between 1 and 15, more preferably between 2 and 10, most preferably less than 5. With an acid value within the preferred ranges, optimal stability can be obtained.

The molecular weight of the polyesteramide obtained in the condensation reaction in step 2 can vary within a wide range and is mainly determined by the ratio of the reactants in the preparation process. Generally, a polyesteramide will be obtained with a molecular weight, determined as the number average molecular weight, Mn, of between 500 and 2,500, preferably between 800 and 2,000, more preferably between 1,000 and 1,600. The Mn is determined by gel permeation chromatography (GPC) against a polystyrene standard using universal calibration.

The glass transition temperature (Tg) of the polyesteramide according to the invention can be varied by the choice of starting components in steps 1 and 2 of the process as described above and thus tailored to their needs. Preferably, the Tg is in the range of 30° to 75° C.

Surprisingly, it was found that the polyesteramide used according to the invention has a high Tg at relatively low molecular weight (Mn). A high Tg is advantageous because of the hardness requirements of the final coating when using resins or other components with high Tg. The Tg is measured by differential scanning calorimetry (DSC) at a scan rate of 10° C./min.

The solvent to be used in conjunction with the polyesteramide is a solvent having coalescing properties and is selected from the group of alcohols, ethers, and ether alcohols having a boiling point at atmospheric pressure in the range of 130-250° C. Examples include 2-ethylhexanol, 4-methyl-2-pentanol, benzyl alcohol, ethyleneglycol monobutyl ether, diethyleneglycol monobutyl ether; diethyleneglycol monoethyl ether; ethyleneglycol phenyl ether; propyleneglycol monobutyl ether, dipropyleneglycol monomethyl ether; dipropyleneglycol monoethyl ether, tripropyleneglycol monoethyl ether, and dipropyleneglycol dimethyl ether. These solvents are entirely or partly soluble in or miscible with water. The solvent suitably has a solubility in water of at least 5 parts of the solvent per 100 parts of water at 25° C.

Next to the polyesteramide and the solvent, the composition that is added to the base coat for overcoming the problem of overspray and/or underspray preferably contains water.

The pH of the additive composition usually is in the range of 5-12 and more preferably in the range of 6-9.

The base coat compositions whose performance with respect to overspray and/or underspray is improved by the addition thereto of the above-described polyesteramide-containing composition according to the invention are aqueous base coat compositions known in the art. Examples thereof can be found in the aforementioned EP-A 0287144 and EP-A 1242548, as well as in EP-A 0608773. In general, one-component (1K) base coats are involved. They contain water, resins, such as polyacrylates, polyesters, and/or polyurethanes, pigments, such as metallic pigments, mica, and inorganic or organic colorants, and other usual additives, such as rheology modifiers, emulsifiers, and solvents. The aqueous base coat composition according to the invention comprises a resin and a pigment, and additionally it contains (i) a water-soluble, branched polyesteramide and (ii) a solvent selected from the group of alcohols, ethers, and ether alcohols having a boiling point in the range of 130° to 250° C.

It should be noted that the resin is a film-forming resin which is different from the branched polyesteramide.

In a preferred embodiment, the aqueous base coat composition according to the invention comprises

10-80 wt. % of resin,
0.5-25 wt. % of pigment,
0.5-25 wt. % of polyesteramide,
5-42 wt. % of organic solvent, including the organic, coalescing solvent originating with the addition of the polyesteramide,
0.5-10 wt. % of additives, such as rheology modifiers and dispersants, and the remainder: water.

Suitably, the coating composition according to the invention has a volatile organic content (VOC) of 420 g/l or less.

Its viscosity suitably is such that it can be sprayed with spray equipment that is available to the skilled person. In practice, this means a viscosity in the range of 40 to 80 mPa·s at a shear rate of 1,000 s⁻¹.

The coating composition according to the invention can be suitably applied to a metal or plastic substrate by spraying. Curing may be carried out at ambient temperature or at elevated temperature to reduce the curing time, for example at a temperature in the range of 50°-120° C. over a period of 10 to 30 minutes. A clear coat can be applied on the base coat wet-on-wet. Alternatively, the base coat may be partially or entirely cured prior to application of the clear coat. This is all known to the skilled person.

The coating composition according to the invention is particularly suitable for the preparation of coated substrates, such as in the car refinish industry, and for finishing large transportation vehicles such as trains, trucks, buses, and airplanes. The coating compositions can also be used for the first finishing of automobiles.

### EXAMPLES

### Method Used for Determining Underspray Absorption

Ready-to-spray (RTS) mixtures of base coat and additive composition were applied by use of a spraying machine. Spray gun used: Satajet RP nozzle 1.4. Test conditions: 30-35° C. and 15-30% relative humidity. Panels of 50×80 cm precoated with filler were sprayed with the formulations to be tested. Spraying program: of the RTS base coat formulation to be tested a first normal layer was applied, covering one third of the panel. After the base coat had become mat and dry by blowing with the spray gun, a second mist coat layer was applied over the first layer, covering half of the panel. After drying of the film a third full layer of the RTS mixture was applied, covering the complete panel. During application of all layers, the formulation was sprayed on the panel from right to left. The panels were visually evaluated on the extent of underspray coarseness detected.

### Method Used for Measuring Viscosity: Wet-on-Wet

Determination of viscosity of pseudoplastic or thixotropic products using a rotational viscometer.

The Volatile Organic Compound level of the ready-to-spray formulation was calculated based on the total volume minus water according to the following formula:

VOC={(100−[Wv−Ww])/(100−[Dc×Ww/Dw])}×Dc×1,000

where Wv=weight percentage of total volatile
Ww=weight percentage of water
Dc=density of the coating composition in g/l at 23° C.
Dw=density of water in g/l at 23° C.

The following methods were used for measuring water sensitivity:

### 1) Resistance to Water Droplets

The result of exposure is evaluated on a 1-10 scale: 1=very poor resistance, strong swelling or dissolving of the coating; 10=excellent resistance, no visual change or softening.

Exposed systems: base coats only.
Aging time of the base coat after application: 24 hours at room temperature.
Exposition time: 4 days.

### 2) Resistance to Humidity, Continuous Condensation 38° C., Exposed Systems: Base Coat/Clear Coat Systems.

Aging time base coat/clear coat systems after application: 1 week at room temperature.

Exposition time in Cleveland humidity cabinet: 240 hours. Visual judgment of blisters takes place immediately after exposure. The density of blisters is scored as F: few, M: medium, MD: medium dense, or D: dense. The size of the blisters is scored on a 0-9 scale [0: very large blisters, 9: very small blisters].

Sikkens Autowave® is a commercial aqueous base coat system from Sikkens and is available to the refinishes and light industrial market. The colours are mixed by a colour mixing machine and demineralized water is added just before use to reduce the viscosity for spray application.

Bayhydrol® VP LS2952 is a polyurethane binder commercially available from Bayer.

Setalux® 6801 is a polyacrylate dispersion and Setal 6306® is a polyester dispersion. Both are commercially available from Nuplex.

Pluriol® P600 is a polypropylene glycol oligomer commercially available from BASF.

Cymel® 303LF is a water dispersable hexamethoxymethyl melamine commercially available from Cytec Industries.

ZW6015 and ZW6017 are water-soluble, branched polyesteramides used in accordance with the invention.

### Preparation of ZW6015

A glass reaction vessel was charged with di-ispropanol amine (615 g) and subsequently heated to 80° C. under a nitrogen atmosphere. Once the amine was molten (Tₘ=42° C.), the stirrer was started. Succinic anhydride (385 g, Tₘ=119° C.) was added to the reaction mixture over a period of 30 minutes. After all the anhydride had been added, the reaction mixture was heated to 160° C. Most of the evolving reaction water was distilled off in about 1 hour. Subsequently, the pressure was slowly decreased to 30 mbar, after which the reaction was continued until the acid number had reached the value of 3.9 mg KOH/g resin. The reaction vessel was then discharged and the product was cooled down to room temperature.

### Preparation of ZW6017

A glass reaction vessel was charged with di-ispropanol amine (759 g) and subsequently heated to 80° C. under a nitrogen atmosphere. Once the amine was molten (Tₘ=42° C.), the stirrer was started. Hexahydrophthalic anhydride (146 g, Tₘ=34° C.) was added over a period of 15 minutes. Subsequently, succinic anhydride (380 g, Tₘ=119° C.) was added to the reaction mixture over a period of 45 minutes.

After all the anhydride had been added, the reaction mixture was heated to 160° C. Most of the evolving reaction water was distilled off in about 1 hour. Subsequently, the pressure was slowly decreased to 30 mbar, after which the reaction was continued until the acid number had reached the value of 2.5 mg

KOH/g resin. The reaction mixture was cooled down to 140° C., after which demi-water (735 g) was added to the reaction vessel and a viscosity of 2.5 Pa·s was reached. The reaction vessel was then discharged and the product was cooled down to room temperature.

The properties of ZW6015 and ZW6017 were as follows:

| | Mn | Tg (° C.) | Acid value | OH value |
|---|---|---|---|---|
| ZW6015 | 1,200 | 55 | 3.9 | 315 |
| ZW6017 | 1,200 | 60 | 2.5 | 305 |

### Results

The addition to Autowave® of 10% and 20% of mixtures of 50% of the cosolvent propylene glycol monopropyl ether or diethyleneglycol methyl ether and 50% water did not show improved overspray/underspray absorption after application of the resulting coating compositions to steel panels and drying. The additions also resulted in VOCs higher than 420 g/l.

Table 1 below lists the underspray absorption results obtained for the Comparative Examples using the 10% additive level.

TABLE 1

| | | Amount added | Underspray absorption |
|---|---|---|---|
| | | to water borne | [1: very poor underspray |
| | Composition | base coat | absorption; 10: excellent |
| | additive | [w %] | underspray absorption |
| Comp. | Standard additive | 10 | 5 |
| Ex. 1 | (demineralized | | |
| | water) | | |
| Comp. | 50/50% w/w | 10 | 4 |
| Ex. 2 | propylene | | |
| | glycol monopropyl | | |
| | ether/water | | |
| Comp. | 50/50% w/w | 10 | 5 |
| Ex. 3 | diethylene | | |
| | glycol methyl | | |
| | ether/water | | |

Autowave® was mixed with several formulations in such a manner that the base coat composition contained just below 420 g/l of VOC.

TABLE 2
Viscosities of various ready-to-spray mixtures of base coat and additive formulations

| | | | | Amount | | |
|---|---|---|---|---|---|---|
| | | Binder | | added to | | |
| | | solids in | | water borne | η at | η at |
| | Binder type in | additive | Cosolvent | base coat | 100 s⁻¹ | 1000 s⁻¹ |
| | additive | [w %] | in (w %] | [w %] | [mPa · s] | [mPa · s] |
| Comp. | Standard | 0 | 0 | 10 | 145 | 67 |
| Ex. 1 | additive | | | | | |
| | (demineralized | | | | | |
| | water) | | | | | |
| Comp. | Polyacrylate, | 7.7 | 14 | 20 | 139 | 66 |
| Ex. 4 | Setalux 6801 | | | | | |
| Comp. | Polyurethane, | 20 | 18 | 20 | 196 | 92 |
| Ex. 5 | Bayhydrol VP | | | | | |
| | LS 2952 | | | | | |
| Comp. | Polyester, Setal | 20 | 0 | 20 | 101 | 62 |
| Ex. 6 | 6306 | | | | | |
| Example 1 | Polyesteramide, | 30 | 20 | 20 | 145 | 76 |
| | ZW6015 | | | | | |

An acceptable viscosity is an application viscosity that does not deviate too much from that of the standard (=Comp. Ex. 1).

As can be seen from the results in Table 2, acceptable viscosities are achieved with the additive according to the invention, which is based on 30 wt. % solids—meaning that more coalescing solvent can be added while remaining VOC compliant. With polyacrylate and polyurethane binders in the additive, no more than 10 wt. % of solid binder may be added to achieve acceptable viscosities, meaning that less of the coalescing solvent can be utilized. Incorporation of more than 10 wt. % of polyurethane, for example, would lead to unacceptably high viscosities.

Steel panels were sprayed with RTS mixtures as given in Table 3. Resistance to water droplets was measured for the dried base coat systems. Resistance to humidity was tested for the complete base coat/clear coat system.

TABLE 3
Resistance to water and resistance to blistering for systems with
various additives

| | | | Amount of | | |
|---|---|---|---|---|---|
| | | Binder | additive added | | Humidity |
| | | solids in | to water borne | | test |
| | Binder type in | additive | base coat | Water | Blisters after |
| | additive | [w %] | [w %] | sensitivity | 240 hours |
| Comp. Ex. 1 | Standard additive | 0 | 10 | 7 | 7F |
| | (demineralized | | | | |
| | water) | | | | |
| Comp. Ex. 6 | Polyester, Setal | 20 | 20 | 2 | 6/7D |
| | 6306 | | | | |
| Example 1 | Polyesteramide, | 30 | 20 | 7.5 | 9F |
| | ZW6015 | | | | |
| Example 2 | Polyesteramide, | 30 | 10 | 8.5 | 7F |
| | ZW6015 | | | | |

As can be seen from Table 3, the properties of the compositions containing the polyester-containing additive were poor. In contrast, the composition according to the invention performed significantly better and was at the same level as the standard (=Comp. Ex. 1).

Steel panels were sprayed with RTS mixtures as given in Table 4 for determining Persoz hardness and tackiness. Additionally, larger panels were sprayed with RTS mixtures in order to visually assess underspray absorption. The compositions differ from each other in the non-VOC component used. Relevant properties of the dried base coats are given in Table 5.

The results show that the compositions according to the invention display substantially the same tackiness and hardness values as the standard (Comparative Example 1=CE 1) especially after drying, and better values than those of Comp. Examples 11-14. The compositions according to the invention do not affect properties in a negative sense, in contrast to the compositions used in Comp. Examples 11-14.

The results also show the superiority of the compositions according to the invention in underspray absorption. It should be noted that due to the use of the additive composition according to the invention (Ex. 1-3), the coating compositions in accordance with the invention have a VOC not exceeding 420 g/l, while the coating compositions according to Comp. Ex. 7-10 have a higher VOC.

TABLE 4
Summary of additives tested in water borne base coat compositions

| | Composition additive formulation | | | | |
|---|---|---|---|---|---|
| | | Binder solids | Diethylene glycol | | Amount of additive added to |
| | | in additive | monobutyl ether in | Demi-water in | water borne base coat |
| | Binder type in additive | [wt. %] | additive [wt. %] | additive [wt. %] | composition [wt. %] |
| Comp. Ex. 1 | Standard additive (demi- | 0 | 0 | 100% | 10% |
| | water) | | | | |
| Example 2 | Polyesteramide, | 30 | 20 | 50 | 10% |
| | ZW6015 | | | | |
| Example 1 | Polyesteramide, | 30 | 20 | 50 | 20% |
| | ZW6015 | | | | |
| Example 3 | Polyesteramide, | 30 | 20 | 50 | 20% |
| | ZW6017 | | | | |
| Comp. Ex. 7 | No binder | 0 | 20 | 80 | 10% |
| Comp. Ex. 8 | No binder | 0 | 30 | 70 | 10% |
| Comp. Ex. 9 | No binder | 0 | 40 | 60 | 10% |
| Comp. Ex. 10 | No binder | 0 | 50 | 50 | 10% |
| Comp. Ex. 11 | Polypropylene glycol | 20 | 20 | 60 | 10% |
| | Pluriol P600 | | | | |
| Comp. Ex. 12 | Polypropylene glycol | 30 | 0 | 70 | 10% |
| | Pluriol P600 | | | | |
| Comp. Ex. 13 | Polypropylene glycol | 20 | 20 | 60 | 20% |
| | Pluriol P600 | | | | |
| Comp. Ex. 14 | Hexamethoxymethyl | 30 | 20 | 50 | 20% |
| | melamine Cymel ® | | | | |
| | 303LF | | | | |

TABLE 5
Properties of base coats of the Examples of Table 4

| | | | Tackiness base | | Underspray |
|---|---|---|---|---|---|
| | Persoz hardness | | coat [10: not | | absorption |
| | base coat | | tacky; 0: very tacky] | | [1: very poor; 10: |
| | 2 days after | 9 days after | 3 hours after | 5 days after | excellent] directly |
| | application | application | application | application | after application |
| Comp. Ex. 1 | 113 | 126 | 10 | 10 | 5 |
| Example 2 | 97 | 120 | 8 | 10 | — |
| Example 1 | 82 | 123 | 6 | 10 | — |
| Example 3 | — | — | — | — | 8 |
| Comp. Ex. 7 | 96 | 131 | 10 | 10 | 6 |
| Comp. Ex. 8 | — | — | — | — | 7.5 |
| Comp. Ex. 9 | 73 | 121 | 8 | 10 | 8.5 |
| Comp. Ex. 10 | — | — | — | — | 9 |
| Comp. Ex. 11 | 34 | 42 | 5 | 6 | — |
| Comp. Ex. 12 | — | — | — | — | 5.5 |
| Comp. Ex. 13 | 28 | 31 | 4 | 4 | — |
| Comp. Ex. 14 | 27 | 35 | 4 | 5 | — |

1. A water borne base coat composition comprising water, a resin, and a pigment, a water-soluble, branched polyesteramide and a solvent selected from the group consisting of alcohols, ethers, and ether alcohols having a boiling point in the range of 130° to 250° C.

2. The composition according to claim 1, wherein the Tg of the polyesteramide is in the range of 30° to 75° C.

3. The composition according to claim 1, wherein the polyesteramide has an Mn in the range of 500 to 2,500 and an OH value in the range of 250 to 350 mg KOH/g.

4. The composition according to claim 1, wherein the polyesteramide is obtained by a process comprising the following steps:
a) reacting 50-100 wt. %, based on the total amount of an anhydride A1, together with 0-50 wt. % of an anhydride A2, with at least one di-β-alkanolamine to form an intermediate product, and
b) performing a polycondensation reaction on the intermediate product obtained in the first step,
wherein the anhydride A1 is chosen from the group consisting of succinic anhydride, methyl succinic anhydride, maleic anhydride, glutaric anhydride and a combination of any of these; and wherein the anhydride A2 is chosen from the group consisting of hexahydrophthalic anhydride, phthalic anhydride methyl-hexahydrophthalic anhydride and a combination of any of these.

5. The composition according to claim 4, wherein the dialkanolamine is selected from the group consisting of di-isopropanolamine, diethanolamine, and di-isobutanolamine.

6. The composition according to claim 1, wherein the solvent is selected from the group consisting of 2-ethylhexanol, 4-methyl-2-pentanol, benzyl alcohol, ethyleneglycol monobutyl ether, diethyleneglycol monobutyl ether, diethyleneglycol monoethyl ether, propyleneglycol monobutyl ether, dipropyleneglycol monomethyl ether, dipropyleneglycol monoethyl ether, tripropyleneglycol monoethyl ether, and dipropyleneglycol dimethyl ether.

7. An additive composition containing
(i) 1-50 wt. % of a water-soluble, branched polyesteramide,
(ii) 1-50 wt. % of a solvent selected from the group consisting of alcohols, ethers, and ether alcohols having a boiling point in the range of 130° to 250° C., and
(iii) 0-98 wt. % of water,
the sum of (i), (ii), and (iii) being 100%.

8. The composition according to claim 7, wherein the Tg of the polyesteramide is in the range of 30° to 75° C.

9. The composition according to claim 7, wherein the Mn of the polyesteramide is in the range of 500 to 2,500 and the OH-value is in the range of 250-350 mg KOH/g.

10. The composition according to claim 7 wherein the solvent is selected from the group consisting of 2-ethylhexanol, 4-methyl-2-pentanol, benzyl alcohol, ethyleneglycol monobutyl ether, diethyleneglycol monobutyl ether, diethyleneglycol monoethyl ether, propyleneglycol monobutyl ether, dipropyleneglycol monomethyl ether, dipropyleneglycol monoethyl ether, tripropyleneglycol monoethyl ether, and dipropyleneglycol dimethyl ether.

11. A substrate at least partially coated with a coating composition according to claim 1 that has been dried.

12. The composition according to claim 2, wherein the polyesteramide has an Mn in the range of 500 to 2,500 and an OH value in the range of 250 to 350 mg KOH/g.

13. The composition according to claim 2, wherein the solvent is selected from the group consisting of 2-ethylhexanol, 4-methyl-2-pentanol, benzyl alcohol, ethyleneglycol monobutyl ether, diethyleneglycol monobutyl ether, diethyleneglycol monoethyl ether, propyleneglycol monobutyl ether, dipropyleneglycol monomethyl ether, dipropyleneglycol monoethyl ether, tripropyleneglycol monoethyl ether, and dipropyleneglycol dimethyl ether.

14. The composition according to claim 3, wherein the solvent is selected from the group consisting of 2-ethylhexanol, 4-methyl-2-pentanol, benzyl alcohol, ethyleneglycol monobutyl ether, diethyleneglycol monobutyl ether, diethyleneglycol monoethyl ether, propyleneglycol monobutyl ether, dipropyleneglycol monomethyl ether, dipropyleneglycol monoethyl ether, tripropyleneglycol monoethyl ether, and dipropyleneglycol dimethyl ether.

15. The composition according to claim 4, wherein the solvent is selected from the group consisting of 2-ethylhexanol, 4-methyl-2-pentanol, benzyl alcohol, ethyleneglycol monobutyl ether, diethyleneglycol monobutyl ether, diethyleneglycol monoethyl ether, propyleneglycol monobutyl ether, dipropyleneglycol monomethyl ether, dipropyleneglycol monoethyl ether, tripropyleneglycol monoethyl ether, and dipropyleneglycol dimethyl ether.

16. The composition according to claim 8, wherein the Mn of the polyesteramide is in the range of 500 to 2,500 and the OH-value is in the range of 250-350 mg KOH/g.

17. The composition according to claim 8 wherein the solvent is selected from the group consisting of 2-ethylhexanol, 4-methyl-2-pentanol, benzyl alcohol, ethyleneglycol monobutyl ether, diethyleneglycol monobutyl ether, diethyleneglycol monoethyl ether, propyleneglycol monobutyl ether, dipropyleneglycol monomethyl ether, dipropyleneglycol monoethyl ether, tripropyleneglycol monoethyl ether, and dipropyleneglycol dimethyl ether.

18. The composition according to claim 9 wherein the solvent is selected from the group consisting of 2-ethylhexanol, 4-methyl-2-pentanol, benzyl alcohol, ethyleneglycol monobutyl ether, diethyleneglycol monobutyl ether, diethyleneglycol monoethyl ether, propyleneglycol monobutyl ether, dipropyleneglycol monomethyl ether, dipropyleneglycol monoethyl ether, tripropyleneglycol monoethyl ether, and dipropyleneglycol dimethyl ether.

19. The composition according to claim 16 wherein the solvent is selected from the group consisting of 2-ethylhexanol, 4-methyl-2-pentanol, benzyl alcohol, ethyleneglycol monobutyl ether, diethyleneglycol monobutyl ether, diethyleneglycol monoethyl ether, propyleneglycol monobutyl ether, dipropyleneglycol monomethyl ether, dipropyleneglycol monoethyl ether, tripropyleneglycol monoethyl ether, and dipropyleneglycol dimethyl ether.

20. A substrate at least partially coated with a coating composition according to claim 6 that has been dried.
